(19) United States
(12) Patent Application Publication
(10) Pub. No.: US 2025/0306290 A1
(43) Pub. Date: Oct. 2, 2025

(54) EXPANDED BEAM OPTICAL COUPLING WITH A BALL LENS

(71) Applicant: Intel Corporation, Santa Clara, CA (US)

(72) Inventors: Fan FAN, Chandler, AZ (US); Jianyong MO, Chandler, AZ (US); Dekang CHEN, Chandler, AZ (US); Feifei CHENG, Chandler, AZ (US); Liang ZHANG, Chandler, AZ (US); Ziyin LIN, Chandler, AZ (US); Kumar Abhishek SINGH, Phoenix, AZ (US); Saikumar JAYARAMAN, Chandler, AZ (US)

(21) Appl. No.: 18/622,579

(22) Filed: Mar. 29, 2024

(51) Int. Cl. G02B 6/36

(52) U.S. Cl. CPC G02B 6/3636

(57) ABSTRACT

Embodiments disclosed herein comprise an apparatus with a substrate with a first surface, and a second surface that is recessed from the first surface. In an embodiment, the second surface is adjacent to an edge of the substrate. In an embodiment, a hole is in the second surface, and a groove is in the first surface. In an embodiment, a centerline of the groove passes over the hole.

### GOVERNMENT LICENSE RIGHTS

This Invention was made with Government support under Agreement No. N00164-19-9-0001, awarded by NSWC Crane Division. The Government has certain rights in the Invention.

### BACKGROUND

Optical data links are potential candidates to address scalability challenges of electrical interconnects over long distances due to their potential for negligible frequency-dependent loss. Co-packaged optics (CPO) are a solution that facilitates the seamless integration of optics and electrical silicon into a single unit. However, progress is impeded by the stringent alignment requirements necessary to connect optical fibers with silicon waveguides.

Connectors that uses expanded beam lenses have been proposed in order to alleviate some of the demanding alignment constraints. The expanding beam lens expands the optical beam in order to increase tolerance to misalignment. However, challenges still remain with respect to accurately aligning micro-lenses to multi-channel fiber centers down to the sub-micron level for optimal performance.

### BRIEF DESCRIPTION OF THE DRAWINGS

FIG. 1A is an expanded beam fiber array unit (EB-FAU) with discrete micro-lenses optically coupled to each of the optical fibers.

FIG. 1B is an EB-FAU with the lens directly contacting the V-groove block.

FIG. 2 is a perspective view illustration of an EB-FAU that comprises ball lenses set into holes of a recessed surface of the EB-FAU substrate, in accordance with an embodiment.

FIG. 3A is a cross-sectional illustration of an EB-FAU that comprises a ball lens and a fiber stop for controlling a placement of a fiber, in accordance with an embodiment.

FIG. 3B is a cross-sectional illustration of an EB-FAU that comprises a ball lens without a fiber stop, in accordance with an embodiment.

FIGS. 4A-4J are cross-sectional illustrations of a process for forming an EB-FAU with a ball lens, in accordance with an embodiment.

FIG. 5 is a process flow diagram of a process for forming an EB-FAU with a ball lens, in accordance with an embodiment.

FIG. 6A is a cross-sectional illustration of a ball lens, in accordance with an embodiment.

FIG. 6B is a cross-sectional illustration of a ball lens with an antireflective coating (ARC), in accordance with an embodiment.

FIG. 7A is a perspective view illustration of a portion of an EB-FAU substrate with a hole that comprises sloped sidewalls, in accordance with an embodiment.

FIG. 7B is a perspective view illustration of a portion of an EB-FAU substrate with a hole that comprises vertical sidewalls, in accordance with an embodiment.

FIG. 8 is a perspective view illustration of a photonics integrated circuit (PIC) with ball lenses, in accordance with an embodiment.

FIG. 9 is a plan view illustration of a portion of a PIC with ball lenses arranged in staggered rows, in accordance with an embodiment.

FIG. 10A is a plan view illustration of an optoelectronic system that comprises an EB-FAU with ball lenses that is optically coupled to a PIC with ball lenses, in accordance with an embodiment.

FIG. 10B is a cross-sectional illustration of the optoelectronic system of FIG. 10A, in accordance with an embodiment.

FIG. 11 is a plan view illustration of an optoelectronic system that comprises an EB-FAU with ball lenses that is optically coupled to a PIC with ball lenses, in accordance with an embodiment.

FIG. 12 is a schematic of a computing device built in accordance with an embodiment.

### DETAILED DESCRIPTION

Described herein are optoelectronic systems, and more particularly, expanding beam optical coupling optoelectronic systems using ball lenses, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

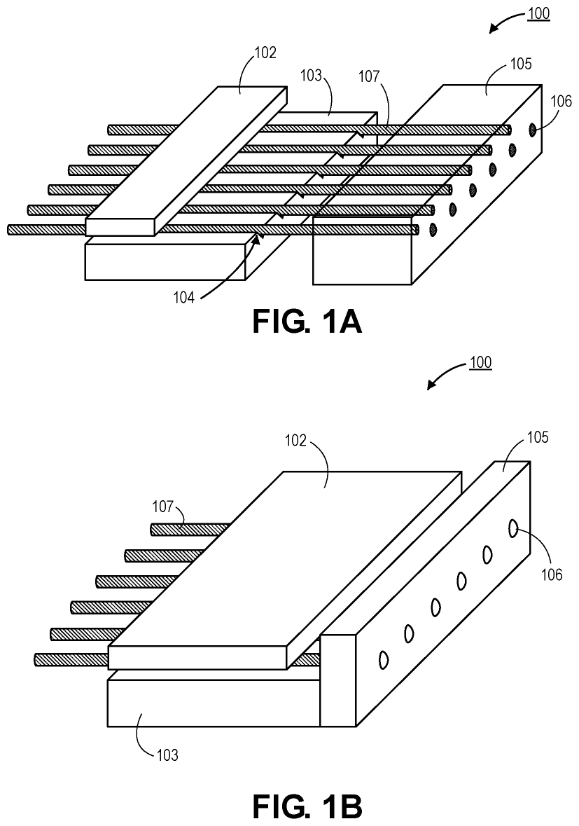

As noted above, existing optical coupling solutions are susceptible significant to optical signal losses even when there is minimal misalignment. In the case of existing expanded beam fiber array units (EB-FAUs), the small expanding beam lenses are mounted to a surface of a lens assembly, and the fibers are inserted into holes of the lens assembly. An example of such an EB-FAU 100 is shown in FIG. 1A. As shown, the assembly 105 may be a glass substrate with a plurality of fibers 107 inserted into holes in the assembly 105. The ends of the fibers 107 are aligned with expanding beam lenses 106 that are provided on a face of the assembly 105. For example, the lenses 106 are glued to the surface of the assembly 105. The use of an adhesive can lead to issues with providing highly repeatable and accurate placement of the lenses 106 relative to the ends of the fibers 107. For example, the fibers 107 may be offset or tilted in some cases. The opposite ends of the fibers 107 may be retained by a support 103 with V-grooves 104. A lid 102 may be provided over the fibers 107 in some instances. FIG. 1B is a similar EB-FAU 100 where the assembly 105 directly contacts the support 103. Additionally, the lenses 106 may be a monolithic structure with the assembly 105. However, there is still a need to attach the assembly 105 to the support 103 (e.g., with an adhesive). As such, sub-micron alignment between the fibers 107 and the lenses 106 is still difficult to obtain.

In addition to the use of adhesives to couple the lenses 106 to the assembly 105, the use of glass for the substrate can also lead to issues. While glass has high dimensional stability, the patterning processes for glass substrates (e.g., etching, laser drilling, etc.) may not have the precision necessary for the highest levels of optical alignment, which may require sub-micron level accuracies.

Accordingly, embodiments disclosed herein include EB-FAUs and photonics integrated circuits (PICs) that use accurately placed ball lenses to implement the beam expansion. In an embodiment, a hole is provided on the EB-FAU or the PIC for holding the ball lens at a highly accurate position relative to the fibers or waveguides. Further, the symmetry of ball lenses simplifies the assembly process, since all orientations of the ball lens are equal to each other with respect to the beam expansion properties. Furthermore, the placement of the hole relative to a V-groove for holding the fiber of an EB-FAU or relative to a waveguide of a PIC can be controlled to a sub-micron accuracy through the use of a semiconductor substrate, such as silicon. High precision patterning processes available to semiconductor substrates enable the highest level of precision for the EB-FAU and/or the PIC. In some embodiments, signal losses attributable to misalignment in embodiments disclosed herein may be approximately 0.1 dB or lower, or approximately 0.01 dB or lower. More generally, embodiments disclosed herein provide improved alignment through control of the placement of features (e.g., ball lenses and V-grooves) in all three dimensions, while also simplifying assembly processes for the optical system.

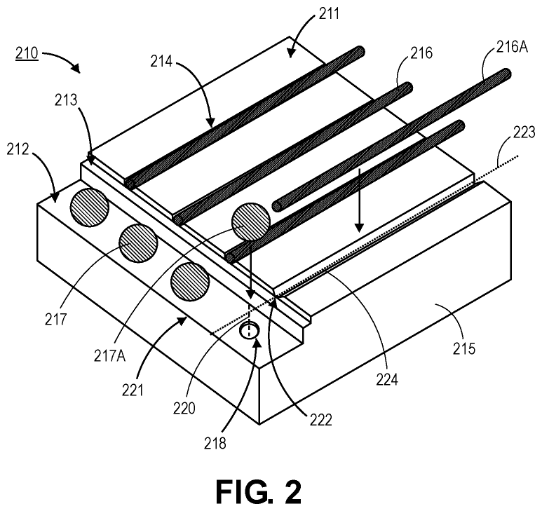

Referring now to FIG. 2, a perspective view illustration of an EB-FAU 210 is shown, in accordance with an embodiment. In an embodiment, the EB-FAU 210 may comprise a substrate 215. The substrate 215 may be a semiconductor substrate, such as a silicon substrate. The use of a semiconductor substrate 215 enables the use of patterning processes that have sub-micron placement and dimensional accuracy. For example, high precision etching processes (e.g., through either a wet etching process or a dry etching process) can be used in order to form alignment features on the substrate 215.

For example, placement of the holes 218 and the V-grooves 214 can be accurately aligned with each other. In one embodiment, a centerline 223 of each V-groove 214 (e.g., a longitudinal centerline 223 along a length of the V-groove 214) passes over an area of a hole 218. More specifically, the centerline 223 of each V-groove 214 may intersect a centerline 220 of a different one of the holes 218. The centerline 220 of the hole 218 may be substantially orthogonal to the centerline 223 of the V-groove 214. It is to be appreciated that a perfect intersection of the centerline 223 and the centerline 220 may not occur due to some alignment tolerances. Accordingly, centerlines that “intersect” may refer to centerlines with a minimum spacing between the two centerlines that is less than 1.0 μm, less than 500 nm, or less than 100 nm in some embodiments.

In an embodiment, the substrate 215 may comprise a plurality of surfaces in order to set heights of different components relative to each other. In an embodiment, a first surface 211, a second surface 212, and a third surface 213 may be provided on the substrate 215. The second surface 212 and the third surface 213 may be recessed from the first surface 211. A recess depth between the second surface 212 and the first surface 211 may be larger than a recess depth between the third surface 213 and the first surface 211. The third surface 213 may be provided between the first surface 211 and the second surface 212. In an embodiment, the second surface 212 may be adjacent to an edge 221 of the substrate 215.

In an embodiment, one or more V-grooves 214 may be formed into the first surface 211. The V-grooves 214 may have a bottom 224 that is below the third surface 213. That is, a maximum depth of the V-grooves 214 may be greater than the recess depth between the first surface 211 and the third surface 213. Accordingly, an edge 222 of the third surface 213 may extend across ends of the V-grooves 214. This structure is useful because it provides a mechanical stop for fibers 216 that are inserted into the V-grooves. As such, all of the fibers 216 will have ends that are a uniform distance from the edge 221 of the substrate 215. The edge 222 may extend partially up a diameter of the fibers 216 so that the optical transmission is not significantly blocked. For example, the edge 221 may cover up to a lower quarter of a diameter of the fibers 216, up to a lower eighth of a diameter of the fibers 216, or up to a lower sixteenth of a diameter of the fibers 216.

As used herein, a “V-groove” may generally refer to a recess into a substrate that is used to align and/or retain a fiber. For example, a V-groove may have a pair of sloping sidewalls that come to a point at a bottom of the V-groove. In other instances, a V-groove may have sloped sidewalls with bottoms that are connected together by a bottom surface (e.g., a horizontal surface or a curved surface). In such an embodiment, the bottom surface may be below a bottom surface of the fiber so that only the sloping sidewall surfaces contact the fiber. A V-groove may also refer to a groove with vertical sidewalls with a flat bottom surface, a curved bottom surface, or the like. In some instances a V-groove may include a U-shaped groove. The fiber may sit entirely within the V-groove, or a portion of the fiber may extend above a top edge of the V-groove. More generally, a “groove” may refer to a V-groove or any other structure for aligning fibers. A groove may have angled sidewalls or a U-shaped profile.

In an embodiment, the hole 218 is formed into the second surface 212. The hole 218 may be sized in order to retain a portion of the ball lens 217. In some embodiments, the hole 218 is circular. Other embodiments may comprise a square hole 218, or any other suitably shaped hole 218 for retaining the ball lens 217. In an embodiment, an epoxy or glue (not visible in FIG. 2) may be provided within the holes 218 to secure the ball lenses 217 to the substrate 215. In an embodiment, recess depths and the dimensions of the hole and V-groove may be designed so that, when assembled, each longitudinal centerline of the fibers 216 passes through a center point of a different one of the ball lenses 217. For example, a centerline that “passes through a center point” of a ball lens may refer to a minimum spacing between the centerline and the center point that is less than 1.0 μm, less than 500 nm, or less than 100 nm in some embodiments.

In an embodiment, the assembly of the EB-FAU 210 is simplified through the use of ball lenses 217. For example, ball lens 217A can be placed (e.g., manually or with a pick-and-place tool) into the hole 218 in any orientation due to the symmetry of the ball lens 217A. Further, the edges of the hole 218 provide a precise way to set the position of the ball lens 217A relative to the fiber 216A. In embodiments with a fiber stopper edge 222, the distance between an end of the fiber 216A and the ball lens 217A can also be well controlled to sub-micron accuracy. The accurate formation of the V-groove 214 also improves alignment of the optical lanes (i.e., an optical fiber 216 that is optically coupled to one of the ball lens 217A).

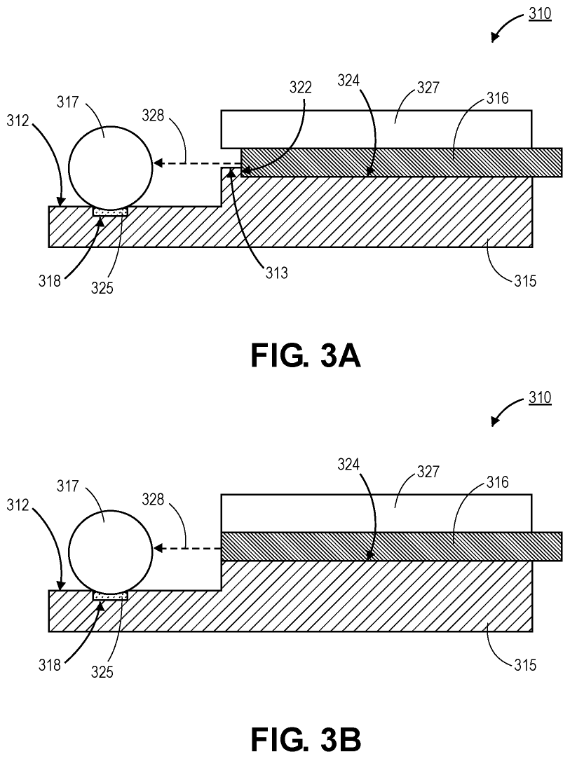

Referring now to FIG. 3A, a cross-sectional illustration of an EB-FAU 310 is shown, in accordance with an embodiment. The plane of the cross-section in FIG. 3A is along a length of the fiber 316 and through the ball lens 317. In an embodiment, the second surface 312 and the third surface 313 of the substrate 315 are visible. The first surface is out of the plane of FIG. 3A. Instead, the bottom 324 of the V-groove is visible. In an embodiment, a fiber 316 is inserted into the V-groove and pushed against the edge 322 of the third surface 313. In an embodiment, a lid 327 (e.g., a glass block or the like) is pressed against a top of the fiber 316 to help retain the fiber 316 within the V-groove.

In an embodiment, the ball lens 317 is set into the hole 318. The ball lens 317 may contact the edges of the hole 318, and a portion of the ball lens 317 may extend into the hole 318. That is, a portion of the ball lens 317 may be provided below the second surface 312. An adhesive 325 (e.g., epoxy or glue) may be provided in the hole 318. The adhesive 325 may secure the ball lens 317 to the edges of the hole 318 in order to maintain proper alignment with the fiber 316. In an embodiment an optical path 328 between the fiber 316 and the ball lens 317 may be provided. In an embodiment, the precision of feature formation and the symmetry of the ball lens 317 allow for excellent optical coupling along optical path 328. For example, signal losses attributable to misalignment between the ball lens 317 and the fiber 316 may be approximately 0.1 dB or lower, or approximately 0.01 dB or lower.

Referring now to FIG. 3B, a cross-sectional illustration of an EB-FAU 310 is shown, in accordance with an additional embodiment. The EB-FAU 310 in FIG. 3B is similar to the EB-FAU 310 in FIG. 3A, with the exception of the fiber stopping feature provided by the third surface 313. Particularly, the third surface 313 is omitted in FIG. 3B. The omission of the fiber stopping feature of the third surface 313 may be suitable when other controls of fiber 316 placement are present to provide the desired spacing between the end of the fiber 316 and the ball lens 317. Further, it is to be appreciated that the use of a beam expander, such as the ball lens 317 allows for greater flexibility in the lateral spacing between the end of the fiber 316 and the ball lens 317 while maintaining high optical coupling efficiency.

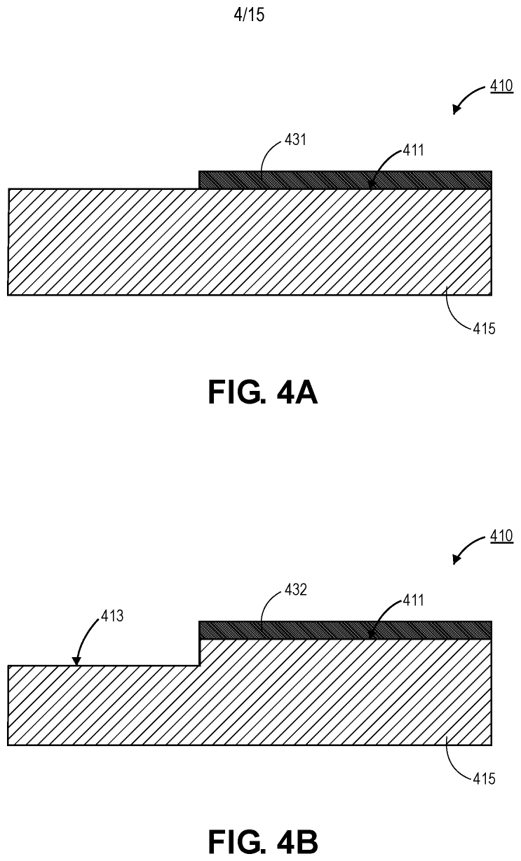

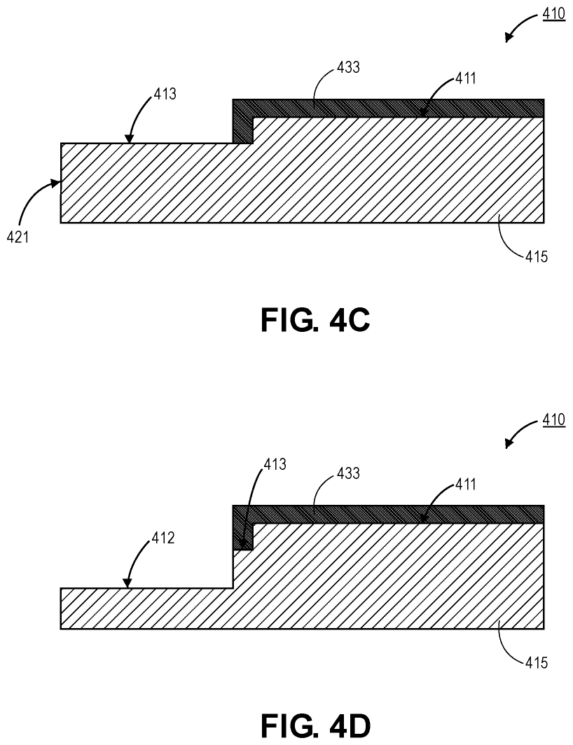

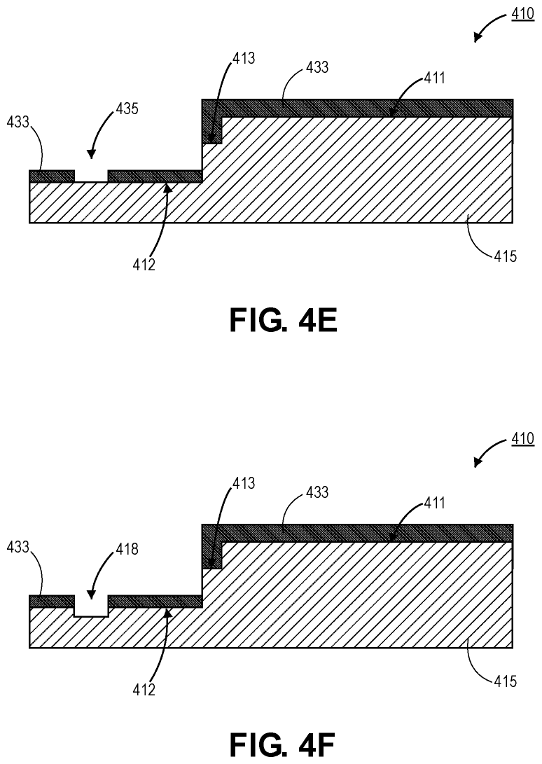

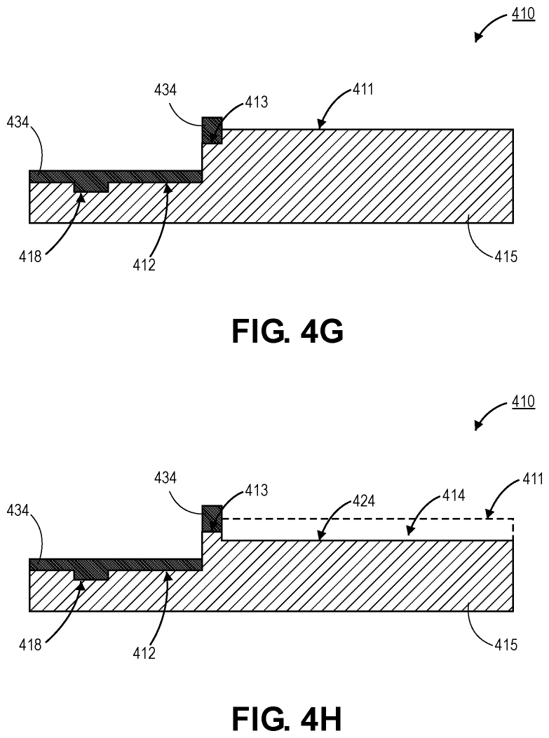

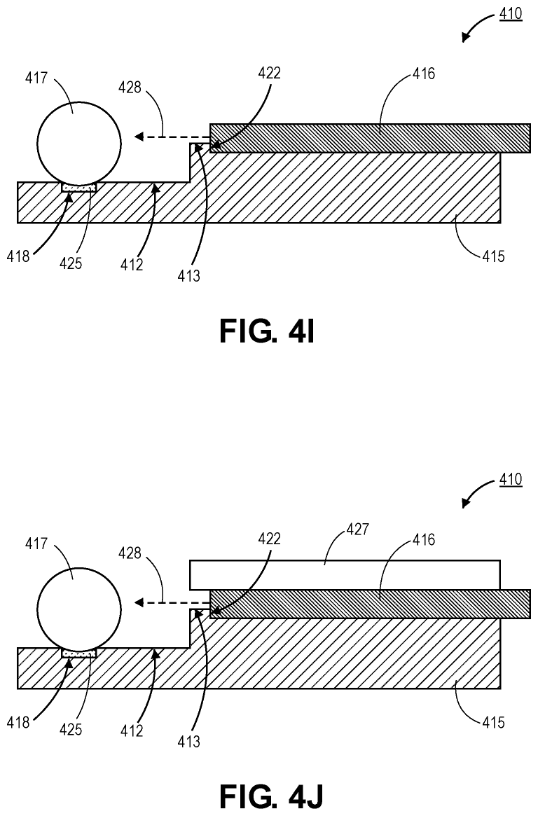

Referring now to FIGS. 4A-4J, a series of cross-sectional illustrations depicting a process for forming an EB-FAU 410 is shown, in accordance with an embodiment. In an embodiment, the EB-FAU 410 may be fabricated with semiconductor processing technology, such as high precision patterning and etching process. Such well developed technology is able to be leveraged in the fabrication of the EB-FAU 410 in order to form features with sub-micron tolerances. For example, feature dimensions and/or feature placement may have errors that are less than 1.0 μm, less than 500 nm, or less than 100 nm in some embodiments.

Referring now to FIG. 4A, a cross-sectional illustration of a portion of an EB-FAU 410 at a stage of manufacture is shown, in accordance with an embodiment. In an embodiment, the EB-FAU 410 may comprise a substrate 415. The substrate 415 may be a semiconductor substrate, such as a silicon substrate. The crystal orientation of the substrate 415 may be provided in order to help with feature patterning. For example, sloped sidewalls of the V-groove and/or hole may be formed through wet etching that is selective along a particular plane. In an embodiment, a resist layer 431 may be provided over a first surface 411 of the substrate 415. The resist layer 431 may be a photoactive polymer material. As shown, the resist layer 431 is patterned so that a portion of the first surface 411 is exposed.

Referring now to FIG. 4B, a cross-sectional illustration of the EB-FAU 410 after a first etching process is shown, in accordance with an embodiment. In an embodiment, the first etching process may result in the recessing of a portion of the substrate 415 relative to the first surface 411. For example, the first etching process may be used to set the recess depth of a third surface 413. The first etching process may be a wet etching process or a dry etching process. While a vertical wall is provided between the third surface 413 and the first surface 411, some embodiments may include a sloped wall as a result of anisotropic etch characteristics. The third surface 413 may ultimately be used in order to form the fiber stopping feature.

Referring now to FIG. 4C, a cross-sectional illustration of the EB-FAU 410 after a second resist layer 432 is deposited and patterned is shown, in accordance with an embodiment. In an embodiment, the second resist layer 432 may cover the first surface 411 and a portion of the third surface 413 that is adjacent to the first surface 411. That is, a portion of the third surface 413 adjacent to an edge 421 of the substrate 415 may be exposed.

Referring now to FIG. 4D, a cross-sectional illustration of the EB-FAU 410 after a second etching process is shown, in accordance with an embodiment. The second etching process may result in the recessing of a portion of the third surface 413 in order to form a second surface 412. Accordingly, embodiments may include two recessed surfaces with different recess depths relative to the first surface 411. For example, the second surface 412 may have the largest recess depth relative to the first surface 411, and the third surface 413 may have a recess depth that puts the third surface 413 between the first surface 211 and the third surface 413 (with respect to a height direction in FIG. 4D).

In an embodiment, the second etching process may be similar to the first etching process. For example, the second etching process may comprise a wet etch or a dry etch. The second etching process may also be different than the first etching process. While a vertical wall is provided between the second surface 412 and the third surface 413, some embodiments may include a sloped wall as a result of anisotropic etch characteristics.

Referring now to FIG. 4E, a cross-sectional illustration of the EB-FAU 410 after a third resist layer 433 is applied, is shown, in accordance with an embodiment. In an embodiment, the third resist layer 433 may be applied over the first surface 411, the third surface 413, and a portion of the second surface 412. In an embodiment, an opening 435 is patterned into the third resist layer 433 over the second surface 412.

Referring now to FIG. 4F, a cross-sectional illustration of the EB-FAU 410 after a third etching process is shown, in accordance with an embodiment. In an embodiment, the third etching process is used to form a hole 418 into the second surface 412. In an embodiment, the depth of the hole 418 may be any suitable depth suitable to retain a ball lens (not shown) and an adhesive. While a vertical sidewall is provided for the hole 418, some embodiments may include a sloped sidewall as a result of anisotropic etch characteristics. The third etching process may be similar to any of the etching processes described herein.

Referring now to FIG. 4G, a cross-sectional illustration of the EB-FAU 410 after a fourth resist 434 is applied is shown, in accordance with an embodiment. In an embodiment, the fourth resist 434 may cover the second surface 412 (including the hole 418) and the third surface 413. A portion of the first surface 411 is exposed. In an embodiment, the fourth resist 434 may also cover some portions of the first surface 411 out of the plane of FIG. 4G. For example, the exposed regions of the first surface 411 correspond to locations where V-grooves are desired.

Referring now to FIG. 4H, a cross-sectional illustration of the EB-FAU 410 after a fourth etching process is shown, in accordance with an embodiment. In an embodiment, the fourth etching process results in the formation of a V-groove 414. For example, a bottom surface 424 of the V-groove 414 is shown in FIG. 4H. The residual first surface 411 is illustrated with a dashed line to indicate the presence of the first surface 411 out of the plane of FIG. 4H. In an embodiment, the fourth etching process may be similar to any of the etching processes described in greater detail herein.

Referring now to FIG. 4I, a cross-sectional illustration of the EB-FAU 410 after optical components are added is shown, in accordance with an embodiment. In an embodiment, a ball lens 417 is placed into the hole 418. For example, the ball lens 417 may contact an outer edge of the hole 418, with a portion of the ball lens 417 extending into the hole 418 below the second surface 412. An adhesive 425 (e.g., epoxy, glue, etc.) may be dispensed into the hole 418 to secure the ball lens 417 to the substrate 415. In an embodiment, a fiber 416 may be inserted into the V-groove 414. In the illustrated embodiment, the fiber 416 is pushed up against edge 422 of the third surface 413. Due to the precise manufacturing processes, the ball lens 417 and the fiber 416 have high optical coupling efficiency along optical path 428.

Referring now to FIG. 4J, a cross-sectional illustration of the EB-FAU 410 after a lid 427 is attached is shown, in accordance with an embodiment. In an embodiment, the lid 427 may press down on the fiber 416 in order to help retain the fiber 416 in the V-groove. The lid 427 may comprise a different material than the substrate 415. For example, the lid 427 may comprise glass or the like.

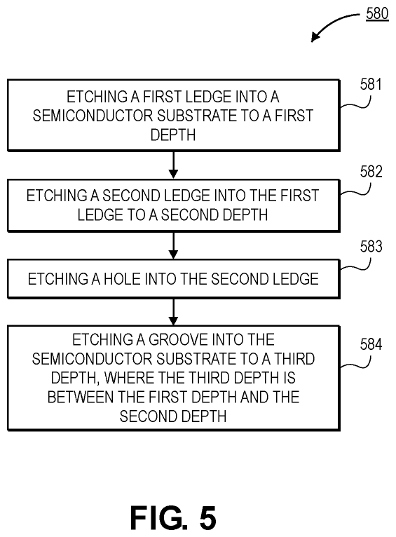

Referring now to FIG. 5, a process flow diagram of a process 580 for forming an EB-FAU is shown, in accordance with an embodiment. In an embodiment, the process 580 may begin with operation 581, which comprises etching a first ledge into a semiconductor substrate to a first depth. In an embodiment, the first ledge may be similar to the third surface 413 described in greater detail above. In an embodiment, the etching process may be a wet or dry etching process.

In an embodiment, the process 580 may continue with operation 582, which comprises etching a second ledge into the first ledge to a second depth. In an embodiment, the second ledge may be similar to the second surface 412 described in greater detail above. In an embodiment, the first depth and the second depth may be measured with respect to the original top surface of the semiconductor substrate. The second depth may be greater than the first depth.

In an embodiment, the process 580 may continue with operation 583, which comprises etching hole into the second ledge. In an embodiment, the hole may be sized to receive and retain a ball lens. For example, the dimensions of the hole may be such that the ball lens sits on the edge of the hole without a bottom of the ball lens contacting a bottom of the hole.

In an embodiment, the process 580 may continue with operation 584, which comprises etching a groove into the semiconductor substrate to a third depth. In an embodiment, the third depth may be between the first depth and the second depth. In an embodiment, the groove may be a V-groove. The groove may end at the first ledge so that a portion of the first ledge crosses an opening at an end of the V-groove.

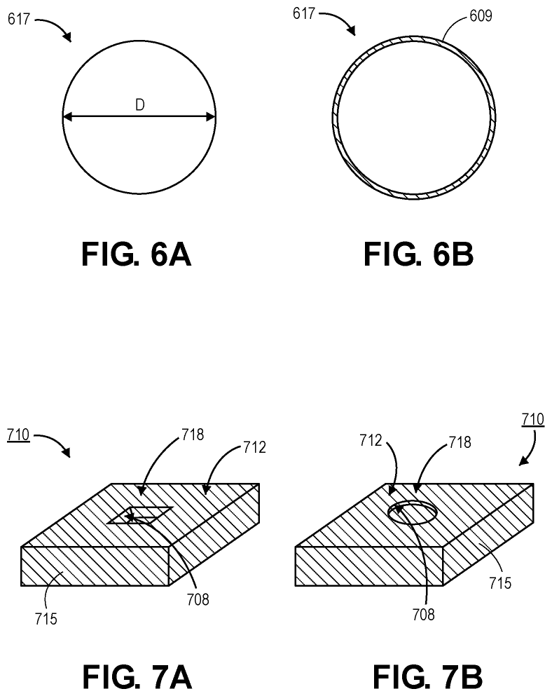

Referring now to FIGS. 6A and 6B, a pair of cross-sectional illustrations of a ball lens 617 is shown, in accordance with an embodiment. In an embodiment, the ball lens 617 may be substantially spherical and substantially symmetric about all straight lines that pass through a center point of the ball lens 617. In an embodiment, the ball lens 617 may have any suitable diameter D. For example, the diameter D may be up to 200 μm, up to 300 μm, or up to 500 μm. Though, embodiments may include any diameter suitable for any of the optical systems disclosed herein. In some embodiments, the ball lens 617 may be described as a bi-convex spherical lens with the same radius of curvature on both sides, and a diameter equal to twice the radius of curvature. The ball lens may comprise glass or any other suitable material that is compatible with optical transmission. In FIG. 6A, the ball lens 617, comprises a single material through the entire diameter D. In FIG. 6B, the ball lens 617 comprises a coating 609. For example, the coating 609 may comprise an antireflective coating (ARC). The use of a coating 609 may further improve optical coupling efficiency by reducing or eliminating reflections at the surface of the ball lens 617.

Referring now to FIGS. 7A and 7B, portions of a pair of EB-FAUS 710 are shown, in accordance with different embodiments. In FIGS. 7A and 7B, only a portion of a second surface 712 of the substrate 715 is shown. The EB-FAUs 710 may be similar to any of the EB-FAUs described in greater detail herein. As shown in FIG. 7A, the hole 718 may have a square area (when viewed from above). The sidewalls 708 of the hole 718 may be sloped. For example, sloped sidewalls 708 may be formed by selective wet etching along the silicon (111) plane to form a hole 718 that is an inverse frustum. As shown in FIG. 7B, the hole 718 may have a circular area (when viewed from above). The sidewalls 708 of the hole may be substantially vertical. For example, a dry etching process may allow for the formation of vertical sidewalls. While a square hole 718 is shown with sloped sidewalls 708, and a circular hole 718 is shown with vertical sidewalls 708, it is to be appreciated that any sidewall 708 profile can be used with any hole 718 shape.

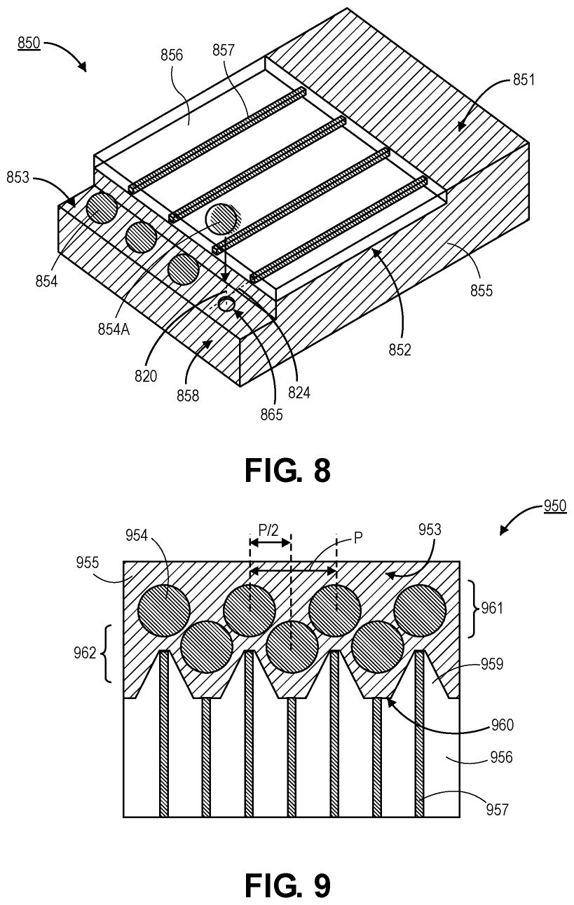

In the description above, reference is made to EB-FAU structures that comprise ball lenses. However, the use of ball lenses is also applicable on the PIC side of the optical system. While specific reference is made to PICs, it is to be appreciated that any optoelectronic system and/or die may include ball lenses with similar alignment precision. For example, co-packaged optics (CPO) devices may be substituted for PICs in some embodiments. An example of such a PIC 850 is shown in FIG. 8.

Referring now to FIG. 8, a perspective view illustration of PIC 850 is shown, in accordance with an embodiment. In an embodiment, the PIC 850 may comprise a substrate 855. The substrate 855 may be a semiconductor substrate, such as a silicon substrate. The use of a semiconductor substrate 855 enables the use of patterning processes that have sub-micron placement and dimensional accuracy. For example, high precision etching processes (e.g., through either a wet etching process or a dry etching process) can be used in order to form alignment features on the substrate 855.

For example, placement of the holes 865 can be accurately aligned with the waveguides 857 within an optical assembly 856. In one embodiment, a longitudinal centerline of waveguide 857 passes over an area of a hole 865. In an embodiment, the waveguides 857 may be formed with a lithographic process, and a cladding and/or cover with a lower index of refraction may be deposited over the waveguides. For example, the cover may comprise silicon and oxygen and/or silicon and nitrogen. More specifically, the centerline of the waveguide 857 may intersect a centerline of one of the holes 865.

In an embodiment, the substrate 855 may comprise a plurality of surfaces in order to set heights of different components relative to each other. In an embodiment, a first surface 851, a second surface 852, and a third surface 853 may be provided on the substrate 855. The second surface 852 and the third surface 853 may be recessed from the first surface 851. A recess depth between the second surface 852 and the first surface 851 may be smaller than a recess depth between the third surface 853 and the first surface 851. The second surface 852 may be provided between the first surface 851 and the third surface 853. In an embodiment, the third surface 853 may be adjacent to an edge 858 of the substrate 855.

In an embodiment, the optical assembly 856 may sit on the second surface 852 of the substrate 855. The optical assembly 856 may comprise a cladding and/or cover material that is deposited over optical waveguides 857. In an embodiment, the waveguides 857 optically couple the ball lens 854 to a photonic device (not shown) of the PIC 850. For example, the photonic device may comprise an optical light source (e.g., laser, etc.) and/or a photodetector.

In an embodiment, the hole 865 is formed into the third surface 853. The hole 865 may be sized in order to retain a portion of the ball lens 854. In some embodiments, the hole 865 is circular. Other embodiments may comprise a square hole 865, or any other suitably shaped hole 865 for retaining the ball lens 854. In an embodiment, an epoxy or glue (not visible in FIG. 8) may be provided within the holes 865 to secure the ball lenses 854 to the substrate 855. In a embodiment, recess depths and the dimensions of the hole 865 may be designed so that, when assembled, each longitudinal centerline 824 of the waveguides 857 passes through a center point 820 of a different one of the ball lenses 854.

In an embodiment, the assembly of the PIC 850 is simplified through the use of ball lenses 854. For example, ball lens 854A can be placed (e.g., manually or with a pick-and-place tool) into the hole 865 in any orientation due to the symmetry of the ball lens 854A. Further, the edges of the hole 865 provide a precise way to set the position of the ball lens 854A relative to the associated waveguide 857.

Referring now to FIG. 9, a plan view illustration of a PIC 950 is shown, in accordance with an additional embodiment. The PIC 950 includes a substrate 955 for supporting a plurality of ball lenses 954 on a surface 953. In order to increases the optical interconnect density of the PIC 950, the ball lenses 954 may be arranged into a first row 961 and a second row 962. In an embodiment, the first row 961 may be shifted over from the second row 962 by half the pitch (P/2) from the second row 962. This allows the ball lenses 954 to overlap so that the shoreline width of the optical interconnects is reduced. In order to keep the distance between waveguides 957 and the ball lenses 954 uniform between the different rows 961 and 962, protrusions 959 may extend out from the optical assembly 956. For example, waveguides 957 that terminate at the tips of the protrusions 959 may be optically coupled to ball lenses 954 in the first row 961, and waveguides 957 that terminate at edge surfaces 960 between protrusions may be optically coupled to ball lenses 954 in the second row 962.

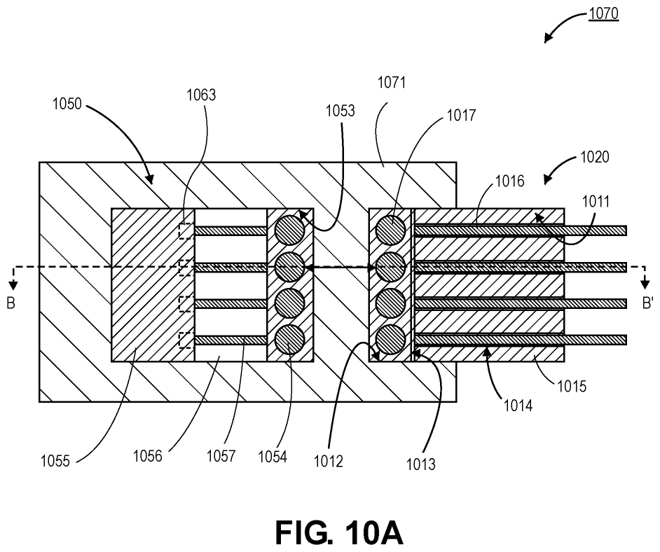

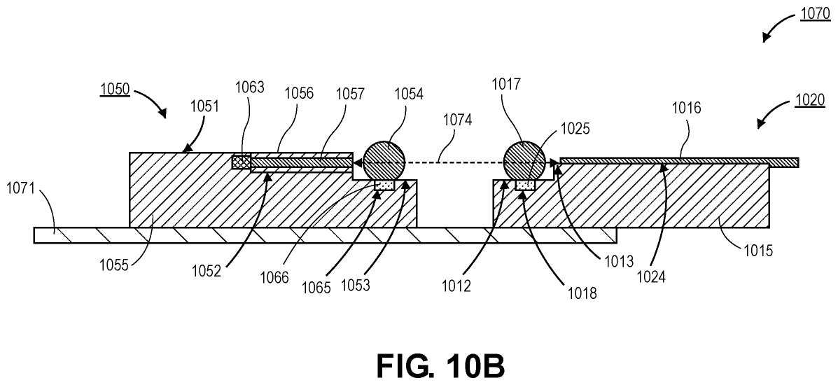

Referring now to FIG. 10A, a plan view illustration of an optical system 1070 is shown, in accordance with an embodiment. In an embodiment, the optical system 1070 may comprise a substrate 1071. A PIC 1050 and an EB-FAU 1020 may be attached to the substrate 1071. In an embodiment, the PIC 1050 and the EB-FAU 1020 may both comprise ball lens optical coupling features. Though, in other embodiments, one of the PIC 1050 or the EB-FAU 1020 may comprise ball lens optical coupling features.

In an embodiment, the PIC 1050 may comprise a substrate 1055 (e.g., a silicon substrate). In an embodiment, an optical assembly 1056 with waveguides 1057 may be optically coupled to ball lenses 1054 that are on a recessed surface 1053 of the substrate 1055. The opposite end of the waveguides 1057 may be coupled to photonics components 1063, such as a laser, a photo-detector, photo-diode, optical modulator, or the like. In some embodiments, a spot size converter may be provided at an end of the waveguides 1057.

In an embodiment, the EB-FAU 1020 may comprise a substrate 1015 that is a semiconductor substrate. A first surface 1011, a second surface 1012, and a third surface 1013 may be provided in some embodiments. V-grooves 1014 for aligning fibers 1016 are provided into the first surface 1011. Ball lenses 1017 are provided on the second surface 1012. The third surface 1013 may be part of a fiber blocking structure to maintain a constant distance between the fibers 1016 and the ball lenses 1017. In an embodiment, the optical coupling efficiency along each optical lane (e.g., with each optical lane comprising a fiber 1016, ball lens 1017, ball lens 1054, and waveguide 1057) is high due to the precision of ball lens 1017 and 1054 placement. For example, losses within the system due to misalignment may be up to approximately 0.1 dB or up to approximately 0.01 dB.

Referring now to FIG. 10B, a cross-sectional illustration of the optical system 1070 in FIG. 10A along line B-B′ is shown, in accordance with an embodiment. As shown, the PIC 1050 comprises a first surface 1051, a second surface 1052, and a third surface 1053. The optical assembly 1056 is supported on the second surface 1052, with the waveguide 1057 optically coupled to the photonics component 1063. The ball lens 1054 sits in a hole 1065 that is at least partially filled with an adhesive 1066.

In an embodiment, the EB-FAU 1020 comprises the substrate 1015 with a second surface 1012 and a third surface 1013 that functions as a block for a fiber 1016. The fiber 1016 sits at the bottom 1024 of a V-groove, and the ball lens 1017 sits in a hole 1018 that is filled with an adhesive 1025. As shown, optical coupling along line 1074 is provided along the entire optical lane. The optical coupling has high coupling efficiency due to the precision provided by patterning features in semiconductor substrates 1055 and 1015 (e.g., silicon) and the symmetry of the ball lenses 1054 and 1017.

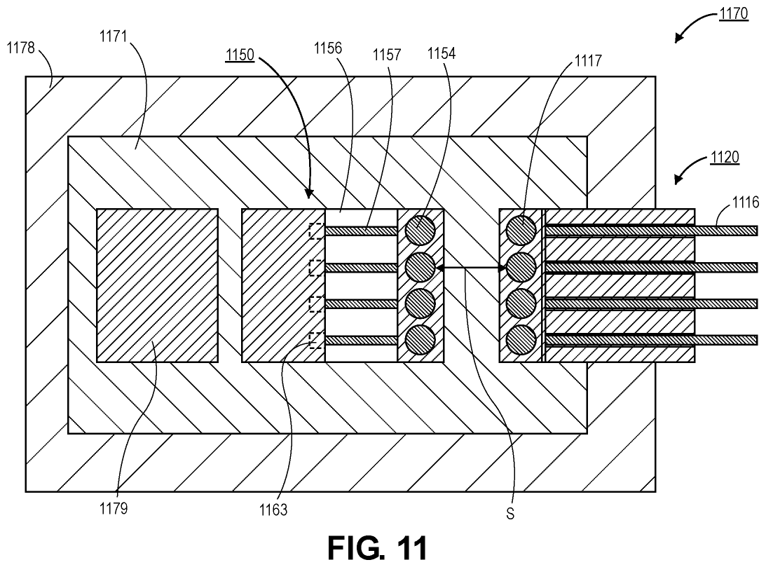

Referring now to FIG. 11, a plan view illustration of an optoelectronic system 1170 is shown, in accordance with an embodiment. The optoelectronic system 1170 may comprise a board 1178, such as a printed circuit board (PCB), a motherboard, or the like. The board 1178 may be coupled to a package substrate 1171 through second level interconnects (SLIs) (not visible). The SLIs may comprise solder joints, pins, sockets, or the like.

In an embodiment, a PIC 1150 and an EB-FAU 1120 are optically coupled to each other on the package substrate 1171. The PIC 1150 may comprise an optical assembly 1156 with waveguides 1157 that optically couple photonics components 1163 to a ball lens 1154. The EB-FAU 1120 may comprise fibers 1116 that are aligned with ball lenses 1117. The opposing ball lenses 1154 and 1117 may be separated by a spacing S. For example, the spacing S may be up to 500 μm, up to 300 μm, or up to 150 μm. The PIC 1150 may be similar to any of the PICs described in greater detail herein, and the EB-FAU 1120 may be similar to any of the EB-FAUs described in greater detail herein.

In an embodiment, the PIC 1150 may be coupled to the package substrate 1171 by any suitable first level interconnect (FLI) architecture (not visible). For example, FLIs may comprise solder bumps, copper bumps, hybrid bonding, and/or the like. In an embodiment, the PIC 1150 may convert optical signals to electrical signals and vice-versa. The PIC 1150 may be communicatively coupled to a die 1179 that is configured to process data delivered along the fibers 1116. The die 1179 may be any type of die 1179, such as a central processing unit (CPU), a graphics processing unit (GPU), an XPU, a communications die, a memory die, or the like.

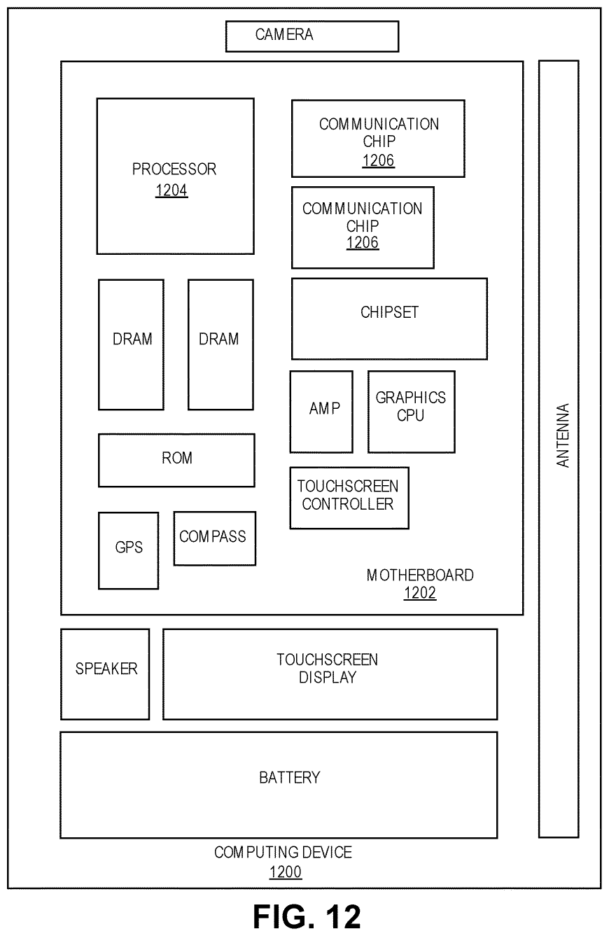

FIG. 12 illustrates a computing device 1200 in accordance with one implementation of the disclosure. The computing device 1200 houses a board 1202. The board 1202 may include a number of components, including but not limited to a processor 1204 and at least one communication chip 1206. The processor 1204 is physically and electrically coupled to the board 1202. In some implementations the at least one communication chip 1206 is also physically and electrically coupled to the board 1202. In further implementations, the communication chip 1206 is part of the processor 1204.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1206 enables wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1206 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1200 may include a plurality of communication chips 1206. For instance, a first communication chip 1206 may be dedicated to shorter range wireless communications such as Wi-Fi and Bluetooth and a second communication chip 1206 may be dedicated to longer range wireless communications such as GPS, EDGE, GPRS, CDMA, WiMAX, LTE, Ev-DO, and others.

The processor 1204 of the computing device 1200 includes an integrated circuit die packaged within the processor 1204. In some implementations of the disclosure, the integrated circuit die of the processor may be part of an optical package that includes expanded beam coupling using one or more ball lenses, in accordance with embodiments described herein. The term “processor” may refer to any device or portion of a device that processes electronic data from registers and/or memory to transform that electronic data into other electronic data that may be stored in registers and/or memory.

The communication chip 1206 also includes an integrated circuit die packaged within the communication chip 1206. In accordance with another implementation of the disclosure, the integrated circuit die of the communication chip may be part of an optical package includes expanded beam coupling using one or more ball lenses, in accordance with embodiments described herein.

In an embodiment, the computing device 1200 may be part of any apparatus. For example, the computing device may be part of a personal computer, a server, a mobile device, a tablet, an automobile, or the like. That is, the computing device 1200 is not limited to being used for any particular type of system, and the computing device 1200 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus comprising: a substrate with a first surface; a second surface of the substrate that is recessed from the first surface, wherein the second surface is adjacent to an edge of the substrate; a hole in the second surface; and a groove in the first surface, wherein a centerline of the groove passes over the hole.

Example 2: the apparatus of Example 1, wherein the substrate comprises silicon.

Example 3: the apparatus of Example 1 or Example 2, wherein the hole has vertical sidewalls.

Example 4: the apparatus of Examples 1-3, wherein the hole has sloped sidewalls.

Example 5: the apparatus of Examples 1-4, wherein the centerline of the groove intersects a centerline of the hole.

Example 6: the apparatus of Examples 1-5, further comprising: a third surface of the substrate recessed from the first surface, wherein the third surface is between the first surface and the second surface, and wherein a bottom of the groove is below the third surface.

Example 7: the apparatus of Example 6, wherein an edge of the third surface crosses an end of the groove.

Example 8: the apparatus of Examples 1-7, further comprising: a ball lens partially within the hole.

Example 9: the apparatus of Example 8, further comprising: an optical fiber in the groove.

Example 10: an apparatus, comprising: a substrate with a first surface; a second surface of the substrate that is recessed from the first surface; a hole into the second surface; and an optical waveguide on the first surface of the substrate, wherein the hole and the optical waveguide are within a same plane.

Example 11: the apparatus of Example 10, wherein the optical waveguide is embedded in a layer comprising silicon and oxygen.

Example 12: the apparatus of Example 10 or Example 11, further comprising: a ball lens partially within the hole.

Example 13: the apparatus of Examples 10-12, wherein the hole is a first hole of a plurality of holes on the second surface, and wherein the optical waveguide is a first optical waveguide of a plurality of optical waveguides on the first surface.

Example 14: the apparatus of Example 13, wherein the plurality of holes comprises a first row of holes and a second row of holes, wherein the second row of holes are offset from the first row of holes, and wherein each of the plurality of optical waveguides are aligned with a different one of the plurality of holes.

Example 15: the apparatus of Examples 10-14, wherein the apparatus is a photonics integrated circuit (PIC).

Example 16: the apparatus of Example 15, wherein the optical waveguide terminates proximate to a photonics component.

Example 17: an apparatus, comprising: a substrate; a photonics integrated circuit (PIC) on the substrate, wherein the PIC comprises: a plurality of first optical lanes, wherein individual ones of the plurality of first optical lanes comprise an optical waveguide and a first ball lens; and a fiber array unit (FAU) on the substrate, wherein the FAU comprises: a plurality of second optical lanes, wherein individual ones of the plurality of second optical lanes comprise a glass fiber and a second ball lens, and wherein individual ones of the plurality of first optical lanes are optically coupled to a different one of the plurality of second optical lanes to form a plurality of paired optical lanes.

Example 18: the apparatus of Example 17, wherein a spacing between the first ball lens and the second ball lens in one of the plurality of paired optical lanes is up to 500 μm.

Example 19: the apparatus of Example 17 or Example 18, wherein the substrate is a package substrate, and wherein the package substrate is coupled to a board.

Example 20: the apparatus of Examples 17-19, wherein the FAU comprises a silicon substrate.

What is claimed is:

1. An apparatus comprising:
a substrate with a first surface;
a second surface of the substrate that is recessed from the first surface, wherein the second surface is adjacent to an edge of the substrate;
a hole in the second surface; and
a groove in the first surface, wherein a centerline of the groove passes over the hole.

2. The apparatus of claim 1, wherein the substrate comprises silicon.

3. The apparatus of claim 1, wherein the hole has vertical sidewalls.

4. The apparatus of claim 1, wherein the hole has sloped sidewalls.

5. The apparatus of claim 1, wherein the centerline of the groove intersects a centerline of the hole.

6. The apparatus of claim 1, further comprising:
a third surface of the substrate recessed from the first surface, wherein the third surface is between the first surface and the second surface, and wherein a bottom of the groove is below the third surface.

7. The apparatus of claim 6, wherein an edge of the third surface crosses an end of the groove.

8. The apparatus of claim 1, further comprising:
a ball lens partially within the hole.

9. The apparatus of claim 8, further comprising:
an optical fiber in the groove.

10. An apparatus, comprising:
a substrate with a first surface;
a second surface of the substrate that is recessed from the first surface;
a hole into the second surface; and
an optical waveguide on the first surface of the substrate, wherein the hole and the optical waveguide are within a same plane.

11. The apparatus of claim 10, wherein the optical waveguide is embedded in a layer comprising silicon and oxygen.

12. The apparatus of claim 10, further comprising:
a ball lens partially within the hole.

13. The apparatus of claim 10, wherein the hole is a first hole of a plurality of holes on the second surface, and wherein the optical waveguide is a first optical waveguide of a plurality of optical waveguides on the first surface.

14. The apparatus of claim 13, wherein the plurality of holes comprises a first row of holes and a second row of holes, wherein the second row of holes are offset from the first row of holes, and wherein each of the plurality of optical waveguides are aligned with a different one of the plurality of holes.

15. The apparatus of claim 10, wherein the apparatus is a photonics integrated circuit (PIC).

16. The apparatus of claim 15, wherein the optical waveguide terminates proximate to a photonics component.

17. An apparatus, comprising:
a substrate;
a photonics integrated circuit (PIC) on the substrate, wherein the PIC comprises:
a plurality of first optical lanes, wherein individual ones of the plurality of first optical lanes comprise an optical waveguide and a first ball lens; and
a fiber array unit (FAU) on the substrate, wherein the FAU comprises:
a plurality of second optical lanes, wherein individual ones of the plurality of second optical lanes comprise a glass fiber and a second ball lens, and wherein individual ones of the plurality of first optical lanes are optically coupled to a different one of the plurality of second optical lanes to form a plurality of paired optical lanes.

18. The apparatus of claim 17, wherein a spacing between the first ball lens and the second ball lens in one of the plurality of paired optical lanes is up to 500 μm.

19. The apparatus of claim 17, wherein the substrate is a package substrate, and wherein the package substrate is coupled to a board.

20. The apparatus of claim 17, wherein the FAU comprises a silicon substrate.
